(19) United States
(12) Patent Application Publication
(10) Pub. No.: US 2026/0162072 A1
(43) Pub. Date: Jun. 11, 2026

(54) COMPUTERIZED METHOD AND SYSTEM FOR AGRICULTURE SCHEDULING

(71) Applicant: Palomar Data Systems Inc., Temecula, CA (US)

(72) Inventors: Kyle Castanon, Wildomar, CA (US); Timothy Burke, Fallbrook, CA (US); Jared Adkins, Menifee, CA (US); Darren Binkley, Temecula, CA (US); Raymond Hayward, Canyon Lake, CA (US)

(73) Assignee: Palomar Data Systems Inc., Temecula, CA (US)

(21) Appl. No.: 19/181,224

(22) Filed: Apr. 16, 2025

Related U.S. Application Data
(60) Provisional application No. 63/635,094, filed on Apr. 17, 2024.

(51) Int. Cl. G06Q 10/109; G06F 3/04817; G06F 3/0484; G06Q 50/02

(52) U.S. Cl. CPC G06Q 10/1097; G06F 3/04817; G06F 3/0484; G06Q 50/02

(57) ABSTRACT

Disclosed is a computer-implemented method for scheduling a harvest on a server system. The method displays, on a graphical user interface, a scheduling module showing multiple harvest groups, each with a plurality of stages assigned to distinct zones. Upon receiving user input to modify a selected stage, the system updates the GUI and automatically assesses zone conflicts and duration conflicts based on minimum and maximum stage durations. Alerts are generated if any zone capacity or duration limits are exceeded. The invention also calculates updated yields and allows user justifications for schedule changes, facilitating flexible yet controlled adjustments to cultivation timelines. This method optimizes resource allocation, improves yield predictability, and preserves crop quality by dynamically managing concurrent harvests.

### CROSS-REFERENCE TO RELATED APPLICATIONS

This application claims benefit of priority with U.S. Provisional Application Ser. No. 63/635,094, filed Apr. 17, 2024; the entire contents of which are hereby incorporated by reference.

### BACKGROUND

### Field of the Invention

This disclosure relates to a computerized method and system for agriculture scheduling, and more particularly to a computerized method and system for agriculture scheduling related to cannabis and related crops.

### Description of the Related Art

Cannabis is typically cultivated in multiple distinct physical zones or rooms corresponding to different stages of plant growth. Modern commercial grow facilities commonly segregate areas for propagation (cloning and seedling), vegetative growth, and flowering, as well as sometimes for post-harvest processes. This zoned cultivation approach is driven by both agricultural and logistical reasons. From an agricultural perspective, each growth stage of the cannabis plant has unique environmental requirements, and dividing the cultivation space into stage-specific zones allows cultivators to optimize conditions for each phase. For example, young plants such as clones or seedlings thrive in a warm, humid environment with gentle light. In contrast, mature plants in the flowering stage perform best in a cooler, drier climate and under strictly controlled 12-hour light/dark cycles to induce and maximize bud production. Photoperiod-dependent cannabis strains should be kept on appropriate light schedules for their stage so co-locating both stages in one space would cause interference. By physically separating these phases into different zones, cultivators can independently control critical environmental parameters like lighting, temperature, humidity, ventilation, and CO₂ enrichment in each area to suit the specific needs of that stage. For example, a dedicated propagation room can maintain high humidity and mild light for rooting cuttings, while a flowering room can be kept dark and dry to prevent mold and promote resin production. This level of stage-specific environmental control ensures that each cohort of plants grows under ideal conditions, thereby improving plant health, consistency, and overall yield quality.

In addition to these horticultural benefits, the use of multiple zones is fundamentally important for optimizing space utilization and workflow efficiency in a cannabis cultivation operation. Segregating the crop into different rooms enables a continuous production model wherein batches of plants are staggered in age and move sequentially through the facility's zones. In practice, as soon as one batch of plants is harvested from the flowering room, the next batch that has been maturing in the vegetative room is ready to move into the flowering zone, and a new set of rooted clones can be brought into the veg room. This pipelined rotation means that no room sits idle waiting for the next crop; at any given time, every zone is populated with plants at some stage of growth. By having all stages always in progress, the facility achieves parallel processing of multiple batches of cannabis. This approach maximizes throughput and yield on a continuous basis, as multiple harvests can be realized in succession without significant downtime. It also makes efficient use of fixed resources and equipment.

Inevitable changes to a stage in one harvest can create conflicts with other harvests as well as effect yield throughput, quality, and revenue. Such a schedule change can set off a chain reaction of conflicts and inefficiencies across all growth stages not just with the altered harvest but with concurrent harvests as well.

### SUMMARY

A computerized method and system are provided to address the unique characteristics and issues with the cultivation of cannabis and relate crops. Existing software solutions do not address these issues which can cause reduction in quality and efficiency. The claimed invention is a computerized method and system specifically designed for scheduling agricultural processes related to cannabis cultivation. It uniquely manages multiple cannabis harvest groups simultaneously, considering each group's strains, stages, zones, plant capacities, and inter-stage dependencies. The system visually represents schedules through a graphical user interface (GUI), enables dynamic adjustments of cultivation stages (including automated shifting of time-bound tasks), and proactively detects conflicts in zone occupancy and stage durations based on defined minimum and maximum stage lengths. By addressing the complexities specific to cannabis cultivation, such as multiple annual harvests, serial and overlapping stage dependencies, and varying strain-specific durations, the invention optimizes resource allocation, improves yield predictability, and maintains crop quality through precise scheduling and conflict resolution mechanisms.

Cannabis harvesters can manipulate and control the life cycle of a cannabis harvest based on amount of light provided. Therefore, multiple cannabis harvests can be completed in a given year. To increase annual output, different harvests are scheduled serially. Delays and changes are a common occurrence which not only affects the current harvest but future harvests as well due to the created dependency. Conventional project management software does not allow for different projects to be dependent to one another. In addition, conventional farm management tools generally deal with crops having a single life cycle in a given year and so planning multiple harvests with different strains using the same harvest location has not been a concern. Having a computerized method and system for providing harvest dependencies can increase quality and output of cannabis cultivation.

Furthermore, cannabis cultivation has other unique characteristics that conventional scheduling tools do not address. Cannabis cultivation involves a plurality of stages for each harvest where each stage occurs in a particular zone. A zone is defined as a unique and separate location designed to perform one or more stages of the cultivation process. Scheduling multiple harvests is not just simply waiting for the first harvest to complete before beginning the next harvest. Instead, annual output can be greatly increased by having multiple harvests occur at the same time, possibly at different parts of the process. However, because a harvest will be moved through different locations (zones), a conflict where too many harvests or plants occupy a particular zone at the same time can occur. Having a computerized method and system for detecting and correcting such conflicts is a solution particularly beneficial to cannabis harvesters.

Additionally, each stage of the harvest generally has a preferred minimum duration and maximum duration based on the one or more strain types growing in the harvest. Cannabis harvesters may want to grow different strains with different harvests, thereby creating harvests having different durations for comparable stages. This can create issues not only for stages of a particular harvest where a stage duration is modified outside of a preferred range, but it can also affect stages of other harvests which have a dependency with the particular harvest. Having a computerized method and system for detecting and correct such issues is a solution particularly beneficial to cannabis harvesters.

Other benefits of the disclosed computerized method and system will be appreciated by one having skill in the art.

### BRIEF DESCRIPTION OF THE DRAWINGS

Other features, combinations, and embodiments will be appreciated by one having the ordinary level of skill in the art of software and cannabis cultivation upon a thorough review of the following details and descriptions, particularly when reviewed in conjunction with the drawings, wherein:

FIG. 1 shows a block diagram of a harvest project in accordance with a first illustrated embodiment;

FIG. 2 shows a method of performing a cultivation of the harvest project according to the first illustrated embodiment;

FIG. 3 shows method of creating a harvest project in accordance with a second illustrated embodiment;

FIG. 4 shows a block diagram of a plurality of harvest projects in accordance with a third illustrated embodiment;

FIG. 5 shows a flowchart for checking conflicts based on change to a task in accordance with a fourth illustrated embodiment;

FIG. 6 shows a flowchart for checking conflicts based on change to a stage in accordance with a fifth illustrated embodiment; and

FIG. 7 shows a graphical user interface in accordance with a sixth illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

The features, components, and configurations described in connection with the various embodiments illustrated herein may be combined, interchanged, or otherwise modified in any number of ways without departing from the scope and spirit of the invention. The embodiments are presented by way of example and not limitation, and it is intended that the invention encompasses all such combinations, permutations, and modifications as would be understood by those skilled in the art.

For purposes herein, the term “harvest group” or “harvest project” means a set of cannabis plants that collectively undergo a scheduled cultivation cycle from initial planting or propagation through harvesting. A harvest group can have one or more strains.

The term “harvest yield” means total output for a particular harvest group. Harvest yield can include total weight/volume as well as weight/volume for particular form factors such as small buds and big buds.

The term “strain” means a specific genetic variation of the cannabis plant. Each strain is generally characterized by distinctive genetic, morphological, and biochemical traits, such as growth pattern, appearance, cannabinoid profile, terpene profile, and other physiological characteristics. Each strain will have a particular minimum duration and maximum duration for each stage of the harvest group.

The term “stage” means a discrete portion within a harvest group and its visual representation on the GUI. Each stage is associated with one of a plurality of zones, and at least two stages with a harvest group will be in different zones. A stage can be modified by changing at least one of the stage start date or the stage end date. Examples of stages can include mother, cloning, pre-vegetative, vegetative, flower, and clean out.

The terms “optimized stage duration” means a preferred range of stage durations based on strain of the harvest group.

The term “minimum duration” means the least amount of time for a stage based on characteristics of the strain being produced. A minimum duration prevents quality degradation.

The term “maximum duration” means the most amount of time for a stage based on characteristics of the strain being produced. A maximum duration prevents quality degradation.

The term “duration conflict” means a stage having a stage duration falling outside the optimized stage duration, such as being less than the minimum duration or more than the maximum duration.

The term “zone” means a visual representation of a physical location where cultivation occurs. Different zones are in separate and distinct locations. A zone can hold one or more harvest groups at one time.

The term “zone conflict” means when either exceeding the plant capacity or the harvest group capacity of a zone at a given time as defined by the grower.

The term “visual differentiation of color” means two colors displayed on a screen that exhibit any distinguishable difference in hue, lightness, or saturation as perceived by a typical human observer.

The term “graphical user interface (GUI)” means a user-facing display system that enables interaction with electronic devices or software through visually represented elements (e.g., icons, menus, windows) and corresponding user inputs, such as keyboard, mouse, or touchscreen actions

The term “server system” means one or more computing devices configured to store, manage, and execute software instructions for implementing the described graphical user interface and harvest scheduling functionality. In various embodiments, the “server system” may be a single physical server, a set of distributed servers (e.g., in a data center or cloud environment), or a local computing device (e.g., a personal computer) on which the software is installed and executed. Thus, the “server system” can include on-premises hardware, virtual machines in remote data centers, or even a client's personal computer operating in a server-like capacity, so long as it is capable of performing the claimed functionalities.

Unless explicitly defined herein, terms are to be construed in accordance with the plain and ordinary meaning as would be appreciated by one having skill in the art.

### General Description of Embodiments

In one general aspect, a computer-implemented method for scheduling a harvest on a server system is disclosed. The computer-implemented method comprises (i) displaying, on a graphical user interface (GUI) provided by the server system, a scheduling module showing a first harvest group and a second harvest group, wherein each harvest group comprises a plurality of stages and each stage is associated with one of a plurality of zones, each of the plurality of zones representing a physically separate location having a plant capacity, and wherein each harvest group further includes a strain type set, a plant count, a harvest start date, and a harvest end date, and each stage includes a stage start date, a stage end date, and a stage duration; (ii) receiving a user input via the GUI to modify a selected stage of the first harvest group resulting in a modification, the modification comprising a change to at least one of the start date or the end date of the selected stage, thereby establishing a modified stage; (iii) in response to the user input, updating the GUI by visually altering a representation of the modified stage on the scheduling module, including at least one of elongating a stage icon for the modified stage, shortening the stage icon, or shifting the stage icon to a new position along the scheduling module; (iv) after applying the modification, automatically assessing for one or more zone conflicts using the server system, a zone conflict defined as at least one of a total number of plants concurrently scheduled in at least one of the plurality of zones exceeding the plant capacity of said zone, or a total number of harvest groups concurrently scheduled in the zone exceeding a harvest group capacity of said zone; (v) automatically assessing for one or more duration conflicts using the server system, a duration conflict defined as the stage duration of the modified stage falling outside an optimized duration range, the optimized duration range comprising a minimum duration and a maximum duration, wherein the optimized duration range is based on the strain type set of the first harvest group; and (vi) displaying an alert of the one or more zone conflicts and the one or more duration conflicts.

In some aspects, the method may further comprise upon modification of the modified stage, automatically calculating by the server system using historical data, an updated yield for the first harvest group based on the modified stage. The method may further comprise displaying the updated yield for the first harvest group on the GUI.

In some aspects, the method may further comprise presenting a justification interface on the GUI to receive a user-provided justification for the modification. The justification interface may be configured to accept from the user at least one of free-text input or a selection from predefined options.

In some aspects, the method may further comprise, after receiving the user input via the GUI to modify the selected stage, displaying a prompt to the user to select one of updating stages of the first harvest group subsequent to the modified stage, and not updating stages of the first harvest group subsequent to the modified stage. In some aspects, the method may further comprise, after displaying the prompt to the user, receiving a user input to automatically propagate updates to stages of the first harvest group subsequent to the modified stage, thereby preserving the duration of the modified stage. In some aspects, the method may further comprise, after displaying the prompt to the user, receiving a user input to not update stages of the first harvest group subsequent to the modified stage, thereby altering the duration of the modified stage.

In some aspects, the method may further comprise visually altering the representation of the modified stage further comprising at least one of a graphically stretching or graphically compressing the duration bar of the modified stage.

In some aspects, the stage icon may visually represent only the stage start date of the modified stage.

In some aspects, the stage duration of the modified stage may be changed from the modification. In some aspects, the stage duration of the modified stage may be unchanged from the modification.

In some aspects, the minimum duration may equal the maximum duration. In some aspects, the minimum duration may be less than the maximum duration.

In some aspects, the first harvest group on the GUI may comprise a first color indicator and the second harvest group on the GUI comprises a second color indicator, the first color indicator being visually differentiated from the second color indicator.

In some aspects, at least two of the plurality of stages of the first harvest group may be in different zones. In some aspects, at least two of the plurality of stages of the second harvest group may be in different zones.

In some aspects, the method may further comprise, prior to receiving the user input via the GUI to modify the selected stage of the first harvest group resulting in a modification, duplicating the scheduling module to provide a testing environment for modification of the modified stage.

In some aspects, each of the plurality of stages of the first harvest group may depend serially with at least one other stage of the plurality of stages of the first harvest group. In some aspects, each of the plurality of stages of the second harvest group may depend serially with at least one other stage of the plurality of stages of the second harvest group.

In some aspects, the total number of plants calculated for the zone conflict may comprise the plant count of the first harvest group and the plant count of the second harvest group. In some aspects, the total number of plants calculated for the zone conflict may comprise the plant count of the first harvest group, the second harvest group, and a third harvest group.

In some aspects, the method may further comprise presenting the first harvest group and the second harvest group concurrently on the scheduling module such that at least one stage of the first harvest group overlaps in time with at least one stage of the second harvest group.

In one general embodiment, a computer system for scheduling a harvest on a server system via a graphical user interface (GUI), the computer system comprising at least one processor and memory that includes instructions that, when executed by the at least one processor, cause the at least one processor to perform steps is disclosed. The steps comprising (i) displaying, on a graphical user interface (GUI) provided by the server system, a scheduling module showing a first harvest group and a second harvest group, wherein each harvest group comprises a plurality of stages and each stage is associated with one of a plurality of zones, each of the plurality of zones representing a physically separate location having a plant capacity, and wherein each harvest group further includes a strain type set, a plant count, a harvest start date, and a harvest end date, and each stage includes a stage start date, a stage end date, and a stage duration; (ii) receiving a user input via the GUI to modify a selected stage of the first harvest group resulting in a modification, the modification comprising a change to at least one of the start date or the end date of the selected stage, thereby establishing a modified stage; (iii) in response to the user input, updating the GUI by visually altering a representation of the modified stage on the scheduling module, including at least one of elongating a stage icon for the modified stage, shortening the stage icon, or shifting the stage icon to a new position along the scheduling module; (iv) after applying the modification, automatically assessing for one or more zone conflicts using the server system, a zone conflict defined as at least one of a total number of plants concurrently scheduled in at least one of the plurality of zones exceeding the plant capacity of said zone, or a total number of harvest groups concurrently scheduled in the zone exceeding a harvest group capacity of said zone; (v) automatically assessing for one or more duration conflicts using the server system, a duration conflict defined as the stage duration of the modified stage falling outside an optimized duration range, the optimized duration range comprising a minimum duration and a maximum duration, wherein the optimized duration range is based on the strain type set of the first harvest group; and (vi) displaying an alert of the one or more zone conflicts and the one or more duration conflicts.

In some embodiments, the steps may further comprise upon modification of the modified stage, automatically calculating by the server system using historical data, an updated yield for the first harvest group based on the modified stage. The steps may further comprise displaying the updated yield for the first harvest group on the GUI.

In some embodiments, the steps may further comprise presenting a justification interface on the GUI to receive a user-provided justification for the modification. The justification interface may be configured to accept from the user at least one of free-text input or a selection from predefined options.

In some embodiments, the steps may further comprise, after receiving the user input via the GUI to modify the selected stage, displaying a prompt to the user to select one of updating stages of the first harvest group subsequent to the modified stage, and not updating stages of the first harvest group subsequent to the modified stage. In some embodiments, the steps may further comprise, after displaying the prompt to the user, receiving a user input to automatically propagate updates to stages of the first harvest group subsequent to the modified stage, thereby preserving the duration of the modified stage. In some embodiments, the steps may further comprise, after displaying the prompt to the user, receiving a user input to not update stages of the first harvest group subsequent to the modified stage, thereby altering the duration of the modified stage.

In some embodiments, the steps may further comprise visually altering the representation of the modified stage further comprising at least one of a graphically stretching or graphically compressing the duration bar of the modified stage.

In some embodiments, the stage icon may visually represent only the stage start date of the modified stage.

In some embodiments, the stage duration of the modified stage may be changed from the modification. In some embodiments, the stage duration of the modified stage may be unchanged from the modification.

In some embodiments, the minimum duration may equal the maximum duration. In some embodiments, the minimum duration may be less than the maximum duration.

In some embodiments, the first harvest group on the GUI may comprise a first color indicator and the second harvest group on the GUI comprises a second color indicator, the first color indicator being visually differentiated from the second color indicator.

In some embodiments, at least two of the plurality of stages of the first harvest group may be in different zones. In some embodiments, at least two of the plurality of stages of the second harvest group may be in different zones.

In some embodiments, the steps may further comprise, prior to receiving the user input via the GUI to modify the selected stage of the first harvest group resulting in a modification, duplicating the scheduling module to provide a testing environment for modification of the modified stage.

In some embodiments, each of the plurality of stages of the first harvest group may depend serially with at least one other stage of the plurality of stages of the first harvest group. In some embodiments, each of the plurality of stages of the second harvest group may depend serially with at least one other stage of the plurality of stages of the second harvest group.

In some embodiments, the total number of plants calculated for the zone conflict may comprise the plant count of the first harvest group and the plant count of the second harvest group. In some embodiments, the total number of plants calculated for the zone conflict may comprise the plant count of the first harvest group, the second harvest group, and a third harvest group.

In some embodiments, the steps may further comprise presenting the first harvest group and the second harvest group concurrently on the scheduling module such that at least one stage of the first harvest group overlaps in time with at least one stage of the second harvest group.

In one general aspect, a non-transitory computer-readable storage medium storing instructions that, when executed by one or more processors, cause the one or more processors to perform a method for scheduling a harvest by a system server via a graphical user interface (GUI). The method comprises (i) displaying, on a graphical user interface (GUI) provided by the server system, a scheduling module showing a first harvest group and a second harvest group, wherein each harvest group comprises a plurality of stages and each stage is associated with one of a plurality of zones, each of the plurality of zones representing a physically separate location having a plant capacity, and wherein each harvest group further includes a strain type set, a plant count, a harvest start date, and a harvest end date, and each stage includes a stage start date, a stage end date, and a stage duration; (ii) receiving a user input via the GUI to modify a selected stage of the first harvest group resulting in a modification, the modification comprising a change to at least one of the start date or the end date of the selected stage, thereby establishing a modified stage; (iii) in response to the user input, updating the GUI by visually altering a representation of the modified stage on the scheduling module, including at least one of elongating a stage icon for the modified stage, shortening the stage icon, or shifting the stage icon to a new position along the scheduling module; (iv) after applying the modification, automatically assessing for one or more zone conflicts using the server system, a zone conflict defined as at least one of a total number of plants concurrently scheduled in at least one of the plurality of zones exceeding the plant capacity of said zone, or a total number of harvest groups concurrently scheduled in the zone exceeding a harvest group capacity of said zone; (v) automatically assessing for one or more duration conflicts using the server system, a duration conflict defined as the stage duration of the modified stage falling outside an optimized duration range, the optimized duration range comprising a minimum duration and a maximum duration, wherein the optimized duration range is based on the strain type set of the first harvest group; and (vi) displaying an alert of the one or more zone conflicts and the one or more duration conflicts.

In some aspects, the method may further comprise upon modification of the modified stage, automatically calculating by the server system using historical data, an updated yield for the first harvest group based on the modified stage. The method may further comprise displaying the updated yield for the first harvest group on the GUI.

In some aspects, the method may further comprise presenting a justification interface on the GUI to receive a user-provided justification for the modification. The justification interface may be configured to accept from the user at least one of free-text input or a selection from predefined options.

In some aspects, the method may further comprise, after receiving the user input via the GUI to modify the selected stage, displaying a prompt to the user to select one of updating stages of the first harvest group subsequent to the modified stage, and not updating stages of the first harvest group subsequent to the modified stage. In some aspects, the method may further comprise, after displaying the prompt to the user, receiving a user input to automatically propagate updates to stages of the first harvest group subsequent to the modified stage, thereby preserving the duration of the modified stage. In some aspects, the method may further comprise, after displaying the prompt to the user, receiving a user input to not update stages of the first harvest group subsequent to the modified stage, thereby altering the duration of the modified stage.

In some aspects, the method may further comprise visually altering the representation of the modified stage further comprising at least one of a graphically stretching or graphically compressing the duration bar of the modified stage.

In some aspects, the stage icon may visually represent only the stage start date of the modified stage.

In some aspects, the stage duration of the modified stage may be changed from the modification. In some aspects, the stage duration of the modified stage may be unchanged from the modification.

In some aspects, the minimum duration may equal the maximum duration. In some aspects, the minimum duration may be less than the maximum duration.

In some aspects, the first harvest group on the GUI may comprise a first color indicator and the second harvest group on the GUI comprises a second color indicator, the first color indicator being visually differentiated from the second color indicator.

In some aspects, at least two of the plurality of stages of the first harvest group may be in different zones. In some aspects, at least two of the plurality of stages of the second harvest group may be in different zones.

In some aspects, the method may further comprise, prior to receiving the user input via the GUI to modify the selected stage of the first harvest group resulting in a modification, duplicating the scheduling module to provide a testing environment for modification of the modified stage.

In some aspects, each of the plurality of stages of the first harvest group may depend serially with at least one other stage of the plurality of stages of the first harvest group. In some aspects, each of the plurality of stages of the second harvest group may depend serially with at least one other stage of the plurality of stages of the second harvest group.

In some aspects, the total number of plants calculated for the zone conflict may comprise the plant count of the first harvest group and the plant count of the second harvest group. In some aspects, the total number of plants calculated for the zone conflict may comprise the plant count of the first harvest group, the second harvest group, and a third harvest group.

In some aspects, the method may further comprise presenting the first harvest group and the second harvest group concurrently on the scheduling module such that at least one stage of the first harvest group overlaps in time with at least one stage of the second harvest group.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### Illustrated Embodiments

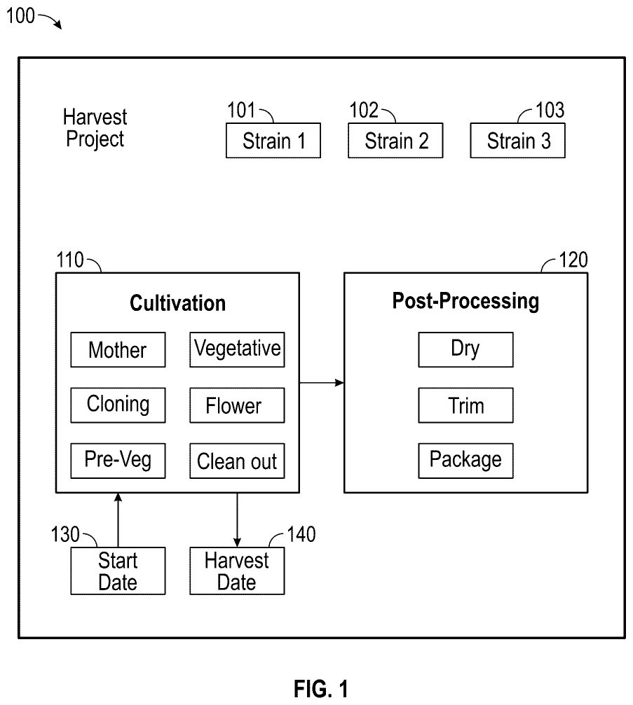

Now turning to the drawings, FIG. 1 shows a block diagram of a harvest project (100) in accordance with a first illustrated embodiment. The harvest project comprises both a cultivation (110) phase and a post-processing (120) phase. The harvest project comprises one or more strains. As shown, the harvest project comprises a first strain (101), a second strain (102), and a third strain (103). In other embodiments, the harvest project may include a different number of strains such as one, two, four, or more. The cultivation phase comprises a plurality of stages. An input to the cultivation phase is a start date (130) which can either be inputted manually by a user or calculated based on preceding harvests already scheduled. Based on the start date and the stages of the cultivation phase, a harvest date (140) can be determined and outputted. Stage durations for each strain are calculated using historical data specific to the strains involved. The duration can be derived from a minimum duration, a maximum duration, or a calculation involving both the minimum and maximum durations. Each strain comprises a specific minimum and maximum duration values for each stage. When different strain types are combined, the longest minimum duration for any given stage should be less than the least maximum duration of said stage to ensure no strain is outside its optimized stage duration, which is defined as being at or within its minimum and maximum durations. Alternatively, in some embodiments, the harvest date (140) can serve as the input, and the start date (130) is calculated by working backward from the harvest date using the stage durations.

The cultivation (110) phase is shown comprising a plurality of distinct stages. Duration of each stage will be based off of the strain types (101; 102; 103) associated with the harvest project (100). The number and sequence of stages depend on the desired outcomes and the grower's preferred terminology. It can be appreciated that names and number of stages will vary with each user. For instance, some growers may combine pre-vegetative and vegetative stages into a single stage, while others may split stages such as the flower stage into sub-stages like early flower and late flower. Upon completion of the cultivation phase, the harvest project is harvested on the harvest date and sent to post-processing (120). The post-processing phase includes drying, trimming, and packaging the crop.

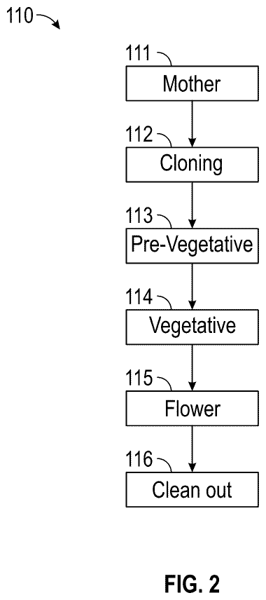

FIG. 2 shows a method of performing a cultivation (After harvest, the clean out stage involves removing plant debris, sanitizing equipment, and resetting the grow space before introducing a new cycle. Pots, trays, and any hydroponic systems are scrubbed or sterilized to eliminate pathogens, while floors, walls, and fans are deep-cleaned to remove residue or hidden pests. Commercial grows may have strict regulations for waste disposal (e.g., shredding stalks) and often conduct equipment maintenance, filter replacements, or room repairs. A thorough cleanout prevents carry-over of diseases and prepares the area for healthy future crops.) of the harvest project according to the first illustrated embodiment. The cultivation includes a plurality of stages including a mother stage (111), a cloning stage (112), a pre-vegetative stage (113), a vegetative stage (114), a flower stage (115), and a clean out stage (116). The stages are performed sequentially, with each stage fully completed before commencing the next. Each of the stages is serially dependent with at least one other of the stages.

In the mother stage (111), growers maintain mature female plants in a perpetual vegetative state so they can continually provide genetic copies (cuttings). Mother plants are exposed to prolonged periods of light (typically 18+ hours daily) to prevent flowering and are regularly pruned or trained to maximize healthy branch tips suitable for cloning. A key goal is preserving desired genetics, especially high-yield or disease-resistant strains, and ensuring the mother remains pest-free and vigorous over many months or years. During this time, the plants focus on foliage and root health, with minimal environmental stress, so they consistently produce strong clones.

The cloning (or propagation) stage (112) takes branch cuttings from a healthy mother plant and encourages them to develop roots, creating genetically identical offspring. Cuttings are placed into rooting media under conditions of high humidity and gentle lighting to prevent wilting. During this period, clones rely on moisture uptake through leaves until they form new roots, so controlling humidity and temperature is critical. Once well-rooted, these clones move on to the next growth stage as independent juvenile plants.

Often called the seedling stage for seed-grown plants (or early rooting/transition for clones), the pre-vegetative (or pre-veg) stage (113) covers the first couple of weeks when a young plant is small and delicate. Newly rooted clones or seedlings are gradually exposed to stronger lighting and modest nutrient feeds, allowing them to build robust root systems before rapid vegetative growth. This stage emphasizes gentle care like avoiding overwatering or harsh light, and is a bridge between fragile sprouts/cuttings and more robust vegetative plants.

In the vegetative stage (114), cannabis plants focus on growing leaves, branches, and roots but do not yet produce buds. Providing extended periods of light (often 18+ hours daily indoors), higher nitrogen nutrients, and adequate watering, plants rapidly construct the physical structure necessary to support subsequent heavy bud growth. Growers may top, train, or prune plants to control height and encourage multiple bud sites, while monitoring pests and pH. Outdoor plants remain in veg until seasonal light decreases, whereas indoor growers choose when to switch to flowering by changing the light cycle (commonly to 12 hours on, 12 off).

The flowering stage (115) begins when daylength shortens (or the light cycle flips to 12/12 indoors), prompting female plants to form buds. After an initial “stretch” (rapid height gain), the plant focuses on producing thick, resinous flowers with high cannabinoid and terpene content. Growers shift to “bloom” nutrients with more phosphorus and potassium, carefully manage humidity and temperature, and often provide supports (stakes, nets) for heavy colas. The flower stage usually lasts 6-10+ weeks depending on strain, ending at harvest when buds reach optimal ripeness.

After harvest, the clean out stage (116) involves removing plant debris, sanitizing equipment, and resetting the grow space before introducing a new cycle. Pots, trays, and any hydroponic systems are scrubbed or sterilized to eliminate pathogens, while floors, walls, and fans are deep-cleaned to remove residue or hidden pests. Commercial grows may have strict regulations for waste disposal (e.g., shredding stalks) and often conduct equipment maintenance, filter replacements, or room repairs. A thorough cleanout prevents carry-over of diseases and prepares the area for healthy future crops.

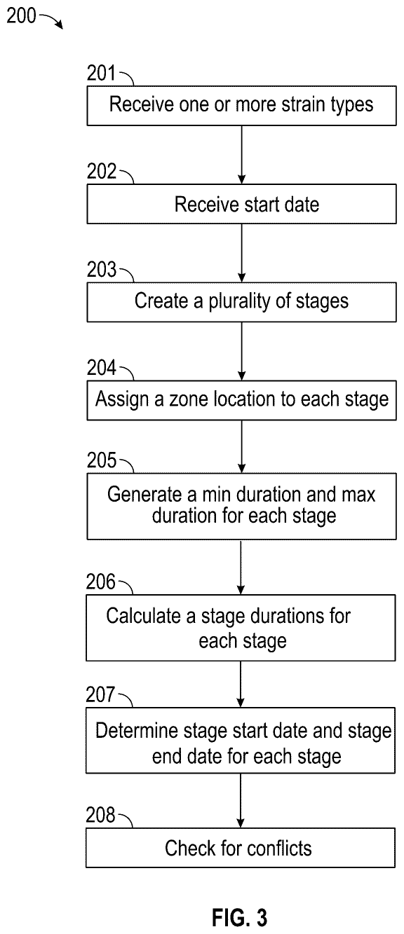

FIG. 3 shows method for creating a harvest project (200) in accordance with a second illustrated embodiment. The method comprises the steps of receiving one or more strain types (201); receiving a start date (202); creating a plurality of stages (203); assigning a zone location to each stage (204); generating a minimum duration and a maximum duration for each stage (205); calculating a stage duration for each stage (206); determining a stage start date and a stage end date for each stage (207); and checking for conflicts (208).

Receiving one or more strain types (201) enables access to historical data, including the minimum and maximum durations for each stage associated with those strains. The number of strain types can vary from a single strain to multiple strains, with the specific number chosen depending on the total number of plants intended for production and the plant capacity within each zone

Creating a plurality of stages (203) can be done manually or automatically from a previous template. The number and type of stages selected may vary according to the specific cultivation objectives and the strain types being produced. In one example, the plurality of stages may comprise Mother, Cloning, Pre-Vegetative, Vegetative, Flower, and Clean Out. Each of the stages is defined as performing one or more particular steps in the harvest process. Those skilled in the art will appreciate that the number and designation of stages can differ among cultivators.

Assigning a zone location to each stage (204) involves assigning a single specific location for the performance of each stage. Zones are defined as a unique and separate location relative to the other zones for performing one or more stages of the harvest project. Individual zones can feature distinct lighting, irrigation systems, temperature controls, and additional specialized equipment that allow optimal conditions for the stages they host. Zones may be identified using letters, numbers, or descriptive titles. If zones are large enough, a single zone may have the capacity to handle multiple harvest projects at one time. Furthermore, different stages from the same harvest project can use the same zone. For example, the stages of Vegetative, Flower, and Clean Out may all take place in the same zone.

Generating a minimum duration and a maximum duration for each stage (205) can be based on historical performance data associated with the selected strain types. The minimum and maximum durations typically comprise empirical data collected from previous harvests, indicating optimal time ranges that produce crops with desirable quality, potency, color, aroma, and other important characteristics

Calculating a stage duration for each stage (206) involves selecting or deriving a duration from the minimum and maximum durations generated in the prior step. In some embodiments, the selected stage duration is the minimum duration, allowing the difference between the minimum and maximum durations to function similarly to slack in conventional project management. In other embodiments, the stage duration is set to the maximum duration, using the minimum duration as a baseline in case a stage start date is delayed or a stage end date is accelerated. In yet other embodiments, the stage duration may be determined using a mathematical combination of the minimum and maximum durations, such as a simple average

Determining a stage start date and a stage end date for each stage (207) involves sequentially adding each stage duration to the start date of the harvest project. Given that the stages are executed sequentially, with each stage fully completed before the subsequent stage begins, the calculated stage durations are cumulatively added to the harvest project start date to establish the individual start and end dates for each stage.

Checking for conflicts (208) can include the software checking for any zone conflicts where the newly created harvest project occupies a zone that another harvest project will occupy during the same time, and that particular zone does not have the capacity for both harvest projects simultaneously. Additionally, conflicts can include verifying that all required stages have been included in the newly created harvest project, based on predefined criteria established by the user.

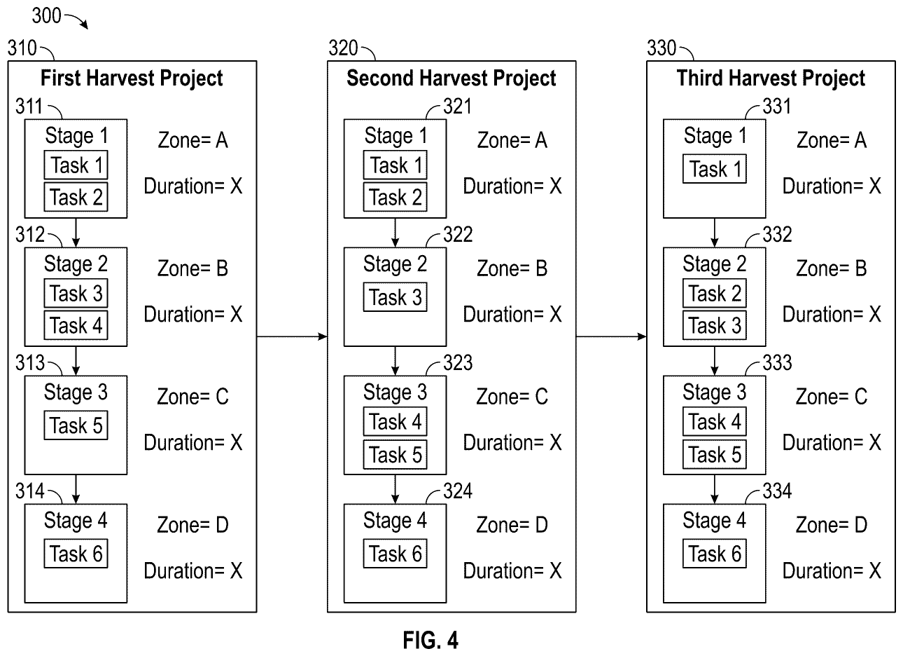

FIG. 4 shows a block diagram of a plurality of harvest projects (300) in accordance with a third illustrated embodiment. The plurality of harvest projects includes a first harvest project (310), a second harvest project (320), and a third harvest project (330). The first harvest project begins prior to the second harvest project, and the second harvest begins prior to the third harvest project. Each of the harvest projects includes a plurality of stages. As illustrated, each harvest project comprises a first stage (311; 321; 331), a second stage (312; 322; 332), a third stage (313; 323; 333), and a fourth stage (314; 324; 334). In some embodiments, the first, second, and third harvest projects include identical first through fourth stages. In other embodiments, the specific stages included within each harvest project can differ. Similarly, while in some embodiments each harvest project may include the same number of stages, in other embodiments the number of stages can vary across the different harvest projects.

Each stage of the first through third harvest projects (310; 320; 330) has an associated duration and assigned zone. The duration and zone assignments for each stage can be manually entered by a user or automatically determined by the system based on historical data from previous harvests. Additionally, each stage has one or more tasks associated with it. Comparable stages across different harvest projects can have either the same or different numbers and types of tasks. Tasks within a stage can be organized according to a preferred or required sequence, ensuring they occur in the appropriate order relative to other tasks within that stage, and relative to tasks within other stages.

Typically, a stage is associated with only one zone. However, a single zone can have sufficient capacity to host multiple stages simultaneously from different harvest projects. If a stage requires multiple zones, it is typically divided into sub-stages, each associated with a distinct single zone. Stage duration for each stage will vary based on strain type of each harvest.

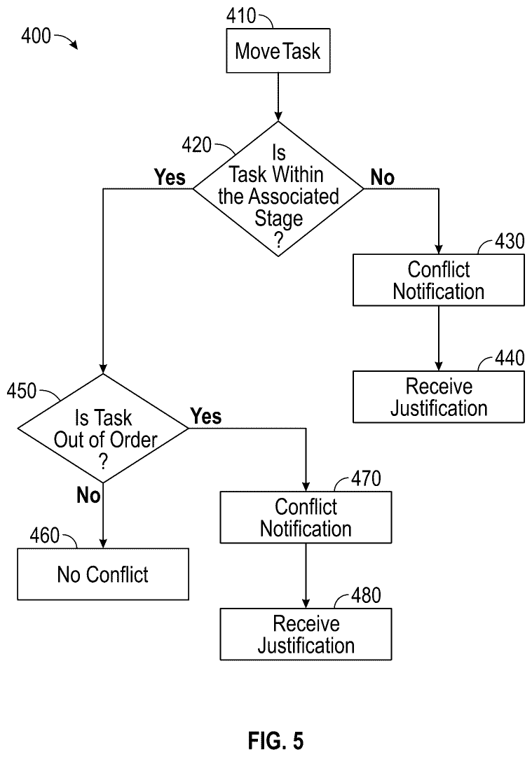

FIG. 5 shows a flowchart for checking conflicts based on a change to a task (400) in accordance with a fourth illustrated embodiment. A user may need to move a task (410) to a different day for various reasons, such as staffing limitations, material availability, or delays impacting other harvest projects. The software verifies whether the rescheduled task still falls within the duration of its associated stage (420). If the task moves outside of the associated stage duration, the software provides the user with a conflict notification (430), accompanied by an input window allowing the user to enter a justification explaining why the task cannot be rescheduled within the original stage duration. The user can either correct the conflict or input a justification (440) explaining why the conflict must remain.

The software can further verify if a task has become out of order (450) following its rescheduling. Conditions within the system, which are established by the user or derived automatically from known industry best practices, determine whether the task order has been violated, prompting the software to issue a conflict notification (470). The conflict can either be corrected by the user or the user can input a justification (480) explaining why the conflict cannot be resolved. For example, if an “early flower prune up” task is delayed and scheduled after the “late flower prune up,” the system will detect this sequence error and generate a conflict notification.

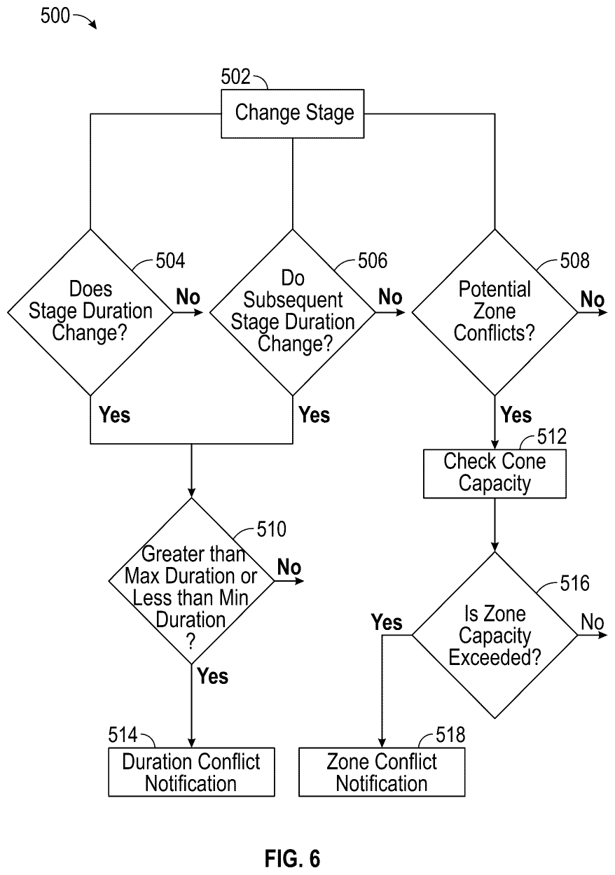

FIG. 6 shows a flowchart for checking conflicts based on change to a stage (500) in accordance with a fifth illustrated embodiment. A user may want to adjust a stage's start date, end date, overall duration, or any combination thereof for various reasons recognized by those skilled in the art. Once a change to the stage (502) is made by the user, the software executes multiple conflict checks based on the modified stage parameters.

One conflict check the software performs is a duration conflict check for the altered stage (504), initially determining if the stage duration has changed due to the user's modification. If the duration has changed, the software then evaluates whether the new duration is shorter than the minimum allowed duration or longer than the maximum allowed duration for that particular stage (510). If either condition occurs, a duration conflict notification is issued to the user (514).

Another conflict check involves evaluating potential duration conflicts affecting other stages (506). Changes to a stage's start date, end date, or duration can affect serially connected stages, either preceding or following the altered stage. The software then assesses whether these adjusted subsequent or preceding stages have durations falling outside their respective minimum or maximum allowable durations (510). If the duration of any affected stage is shorter than its minimum or exceeds its maximum allowable duration, the software provides a duration conflict notification to the user (514).

Additionally, the software checks for zone conflicts (508) resulting from modifications to a stage. Changing a stage's start date, end date, or duration could result in overlapping occupancy of a zone by multiple stages from different harvest projects, potentially exceeding the plant or harvest group capacity of that zone. When the software identifies that two stages from separate harvest projects are scheduled for the same zone on overlapping dates, it calculates the zone's capacity (512). Capacity calculations may depend on the total number of plants, known for each harvest project, or the number of concurrent harvest groups allowed within the zone if standardized plant counts per harvest group are used. The software then determines if the identified zone capacity will be exceeded by the overlapping schedules (516). If the zone's capacity is exceeded, the software generates and provides a zone conflict notification to the user (518).

In some embodiments, a stage's duration may represent an optimal number of days determined by selecting either a minimum, maximum, or an average duration. When a stage is modified, some embodiments shift both the start date and end date simultaneously to preserve the stage's original duration. In alternative embodiments, adjusting a stage alters only the start date or only the end date, consequently modifying the duration of the stage itself. If a stage is moved forward, subsequent stages may or may not shift accordingly, based upon whether the user selects the option to shift all subsequent events of the associated harvest group. Additionally, the stage immediately preceding the adjusted stage may or may not move forward with it. In some scenarios, if the preceding stage does not shift forward, a temporal gap will exist between the newly moved stage and its preceding stage.

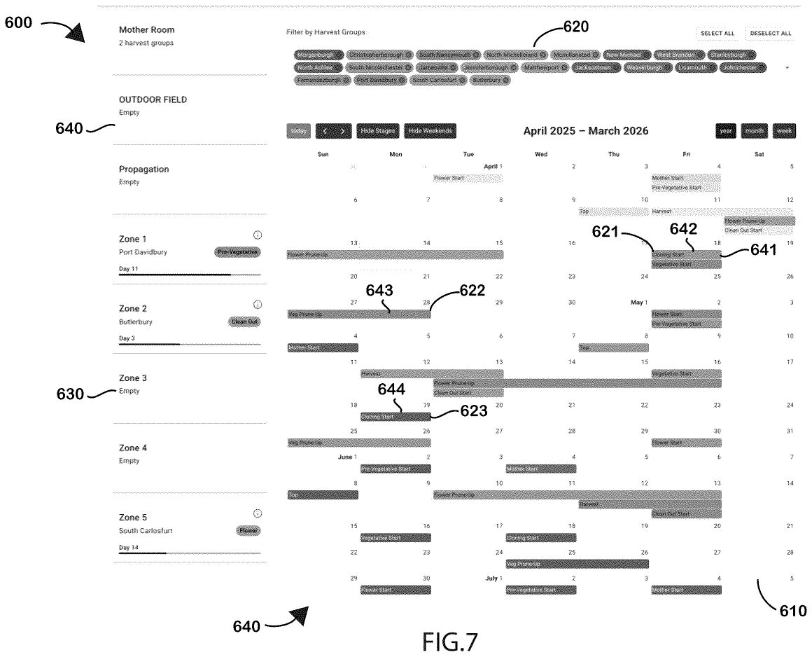

FIG. 7 shows a graphical user interface (600) in accordance with a sixth illustrated embodiment. The graphical user interface includes a scheduling module (610) displaying multiple weeks of a calendar year. Positioned above the scheduling module is a plurality of harvest groups (620), visually differentiated by unique names and colors. Adjacent to the scheduling module is a plurality of stages (640), each with selectable icons allowing the user to view a particular stage and all related harvest groups associated with that stage. Also adjacent to the scheduling module is a plurality of zones (630) with selectable icons, enabling users to select a specific zone and view all associated stages scheduled within that zone. The scheduling module includes a first harvest group (621), a second harvest group (622), and a third harvest group (623), among other harvest groups. The first through third harvest groups are visually differentiated by unique color indicators. Specifically, the first harvest group comprises a first color indicator (642), the second harvest group comprises a second color indicator (643), and the third harvest group comprises a third color indicator (644) wherein the first, second, and third color indicators are visually distinguished from each other.

The scheduling module (610) visually represents the stages (640) associated with each harvest group (620). Each stage, along with any associated tasks, is visually depicted by a stage icon (621). Tasks can include milestones marking the beginning of a stage, such as “cloning start”, “vegetative start,” “flower start,” etc. Tasks may also include time-bound events, which must be performed at specific intervals relative to the stage start date. When a stage containing a time-bound task is shifted, the time-bound task automatically adjusts accordingly. For example, if “topping” must be performed on Day 7 of the vegetative stage, moving the vegetative stage start date forward causes the “topping” task to shift as well, maintaining its relative position at Day 7. Stage icons can visually represent a specific day within the scheduling calendar, such as the first day of a particular stage. Adjusting the start date of a stage will shift the entire stage, including all associated time-bound tasks. Moreover, moving the start date of a stage will affect the duration of the immediately preceding stage within the same harvest group. Some tasks within a stage are not time-bound and will lengthen or shorten based on the available duration allocated for that stage.

User-driven visual modifications within the GUI (600) can include stretching, compressing, and drag-and-drop adjustments. Using drag-and-drop to adjust stage icons, particularly the icons representing stage start dates, assists users in effectively managing and editing schedules, especially when numerous conflicts exist. Typically, the scheduling module is duplicated in a testing environment, enabling users to initially input and evaluate schedule adjustments without immediately implementing permanent changes.

The GUI (600) allows users to shorten, elongate, or reposition stage icons based on user input. The system server responsible for displaying the GUI also performs checks for zone and duration conflicts resulting from user modifications and provides notifications if conflicts are detected. Additionally, the GUI can display a justification interface whenever conflicts arise and are accepted by the user. The justification interface appears in response to zone or duration conflicts triggered by user-inputted changes. Users can input explanations into the justification interface via free-form text or select from predefined justification options. In some embodiments, the justification interface collects data to better understand reasons behind scheduling changes, facilitating improvements in future harvests. In other embodiments, the system allows schedule modifications based solely on a pre-approved justification list. If the user's justification is on the pre-approved list, the system permits the schedule change; otherwise, it disallows the change, notifies the user, or both.

The system server can also recalculate and display an updated harvest yield based on changes made to stages within harvest groups. This feature aids users in determining whether shortening a modified stage is more financially advantageous than delaying the entire harvest group. The decision between shortening the modified stage or shifting all subsequent stages involves financial considerations for the user. Shortening or elongating a modified stage from its optimal duration may negatively impact yield and quality, causing financial implications. Alternatively, delaying all subsequent stages to avoid shortening the modified stage can also have significant financial consequences due to postponed harvest dates. The computerized method and graphical user interface improve the management of maximum concurrent harvest groups by optimizing schedules within resource constraints, thus enhancing harvest throughput. Accurate timing of harvest dates is especially critical in cannabis cultivation, as the harvested product is perishable and susceptible to rapid degradation after harvest.

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

It should be understood that in computer-implemented or software-based methods (e.g., those involving GUIs, servers, or data processing systems), the steps recited in the claims need not be performed in any particular order unless a specific sequence is explicitly required by the context or language of the claim. Steps may be performed in any suitable sequence or even in parallel—for instance, certain user interface interactions and server processes can occur concurrently—without departing from the scope of the invention. Additionally, certain steps may be optional or conditional: extra steps may be included or some steps may be omitted, combined, or repeated as appropriate in different embodiments. The enumeration of steps in this specification or in the claims is merely for clarity and convenience, and no individual step or order should be construed as indispensable or limiting unless expressly stated otherwise. Various modifications, additions, or equivalents of the described steps (for example, implementing a given function via different software modules or in hardware) may be employed by those skilled in the art without departing from the spirit of the invention, and all such changes are intended to fall within the scope of the claims.

### FEATURE LIST

harvest project (100)
first strain (101)
second strain (102)
third strain (103)
cultivation (110)
mother stage (111)
cloning stage (112)
pre-vegetative stage (113)
vegetative stage (114)
flower stage (115)
clean out stage (116)
post-processing (120)
start date (130)
end date (140)
plurality of harvest projects (300)
first harvest project (310)
first stage (311; 321; 331)
second stage (312; 322; 332)
third stage (313; 323; 333)
fourth stage (314; 324; 334)
second harvest project (320)
third harvest project (330)
graphical user interface (600)
scheduling module (610)
harvest groups (620)
first harvest group (621)
second harvest group (622)
third harvest group (623)
plurality of zones (630)
plurality of stages (640)
stage icon (641)
first color indicator (642)
second color indicator (643)
third color indicator (644)

What is claimed is:

1. A computer-implemented method for scheduling a harvest on a server system, the method comprising:
displaying, on a graphical user interface (GUI) provided by the server system, a scheduling module showing a first harvest group and a second harvest group, wherein each harvest group comprises a plurality of stages and each stage is associated with one of a plurality of zones, each of the plurality of zones representing a physically separate location having a plant capacity, and wherein each harvest group further includes a strain type set, a plant count, a harvest start date, and a harvest end date, and each stage includes a stage start date, a stage end date, and a stage duration;
receiving a user input via the GUI to modify a selected stage of the first harvest group resulting in a modification, the modification comprising a change to at least one of the start date or the end date of the selected stage, thereby establishing a modified stage;
in response to the user input, updating the GUI by visually altering a representation of the modified stage on the scheduling module, including at least one of elongating a stage icon for the modified stage, shortening the stage icon, or shifting the stage icon to a new position along the scheduling module;
after applying the modification, automatically assessing for one or more zone conflicts using the server system, a zone conflict defined as at least one of a total number of plants concurrently scheduled in at least one of the plurality of zones exceeding the plant capacity of said zone, or a total number of harvest groups concurrently scheduled in the zone exceeding a harvest group capacity of said zone;
automatically assessing for one or more duration conflicts using the server system, a duration conflict defined as the stage duration of the modified stage falling outside an optimized duration range, the optimized duration range comprising a minimum duration and a maximum duration, wherein the optimized duration range is based on the strain type set of the first harvest group; and
displaying an alert of the one or more zone conflicts and the one or more duration conflicts.

2. The computer-implemented method of claim 1, further comprising upon modification of the modified stage, automatically calculating by the server system using historical data, an updated yield for the first harvest group based on the modified stage.

3. The computer-implemented method of claim 2, further comprising displaying the updated yield for the first harvest group on the GUI.

4. The computer-implemented method of claim 1, further comprising presenting a justification interface on the GUI to receive a user-provided justification for the modification.

5. The computer-implemented method of claim 4, wherein the justification interface is configured to accept from the user at least one of free-text input or a selection from predefined options.

6. The computer-implemented method of claim 1, further comprising, after receiving the user input via the GUI to modify the selected stage, displaying a prompt to the user to select one of updating stages of the first harvest group subsequent to the modified stage, and not updating stages of the first harvest group subsequent to the modified stage.

7. The computer-implemented method of claim 6, further comprising, after displaying the prompt to the user, receiving a user input to automatically propagate updates to stages of the first harvest group subsequent to the modified stage, thereby preserving the duration of the modified stage.

8. The computer-implemented method of claim 6, further comprising, after displaying the prompt to the user, receiving a user input to not update stages of the first harvest group subsequent to the modified stage, thereby altering the duration of the modified stage.

9. The computer-implemented method of claim 1, further comprising visually altering the representation of the modified stage further comprising at least one of a graphically stretching or graphically compressing the duration bar of the modified stage.

10. The computer-implemented method of claim 1, wherein the stage icon visually represents only the stage start date of the modified stage.

11. The computer-implemented method of claim 1, wherein the stage duration of the modified stage is changed from the modification.

12. The computer-implemented method of claim 1, wherein the stage duration of the modified stage is unchanged from the modification.

13. The computer-implemented method of claim 1, wherein the minimum duration is less than the maximum duration.

14. The computer-implemented method of claim 1, wherein the first harvest group on the GUI comprises a first color indicator and the second harvest group on the GUI comprises a second color indicator, the first color indicator being visually differentiated from the second color indicator.

15. The computer-implemented method of claim 1, wherein at least two of the plurality of stages of the first harvest group are in different zones.

16. The computer-implemented method of claim 15, wherein at least two of the plurality of stages of the second harvest group are in different zones.

17. The computer-implemented method of claim 1, further comprising, prior to receiving the user input via the GUI to modify the selected stage of the first harvest group resulting in a modification, duplicating the scheduling module to provide a testing environment for modification of the modified stage.

18. The computer-implemented method of claim 1, wherein each of the plurality of stages of the first harvest group depends serially with at least one other stage of the plurality of stages of the first harvest group.

19. The computer-implemented method of claim 1, wherein the total number of plants calculated for the zone conflict comprises the plant count of the first harvest group and the plant count of the second harvest group.

20. The computer-implemented method of claim 1, further comprising presenting the first harvest group and the second harvest group concurrently on the scheduling module such that at least one stage of the first harvest group overlaps in time with at least one stage of the second harvest group.
